(19) United States
(12) Patent Application Publication
(10) Pub. No.: US 2008/0300917 A1
(43) Pub. Date: Dec. 4, 2008

(54) Interactive Patient Care System

(75) Inventors: John C. Ryan, Boston, MA (US); Daniel Simms, Sunnyvale, CA (US); Egami Tadashi, Belmont, CA (US); Jeffrey Perry, Sunnyvale, CA (US); Neal Goldberg, Santa Rosa, CA (US); Gilberg Lemke, Los Gatos, CA (US); Brian Zhou, San Jose, CA (US); David Moberly, Palo Alto, CA (US); Robert Leichner, Menlo Park, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,084

(22) PCT Filed: Oct. 2, 2006
(86) PCT No.: PCT/IB2006/053596

§ 371 Date: Apr. 22, 2008

Related U.S. Application Data
(60) Provisional application No. 60/730,088, filed on Oct. 25, 2005.

(51) Int. Cl. G06Q 50/00

(52) U.S. Cl. 705/2

(57) ABSTRACT

A patient information system and method are described. The system provides patient interaction via a display.

The cost of health care continues to increase. One aspect of the cost associated with health care is labor. In particular, the costs associated with sufficiently staffing health care facilities are substantial. Furthermore, there is a shortage of qualified personnel to provide certain types of care. Accordingly, the labor costs coupled with a shortage of qualified health care providers can result in limited health care at a relatively high cost. Moreover, the limited level of care often results in the treatment of patients only when urgent care is needed. As is known, the costs associated with urgent care are significant.

In an effort to reduce the cost of health care and to provide a better level of care and associated quality of life to patients, preventive health care continues to be implemented by the health care community. In particular, health care providers strive to provide access to information to their patients so that patients with chronic conditions can take steps to avoid the need for urgent care and so the patients can enjoy their lives more fully in spite of their conditions.

Current methods of providing information to patients are often inefficient and ineffective. Moreover, current methods often only provide information generically to patients according to a medical condition and do not account for specific conditions and needs of the individual patient.

One way to provide individual care information to patients requires access to health care professionals via the telephone or other medium. For example, if a patient requires information he or she may contact their physician's office and speak to a nurse or other health care professional. Alternatively, each nurse of a physician's office may be assigned to certain patients and will contact the patients periodically to render information and care based on each patient's current condition and needs. Unfortunately, this method has shortcomings. First, as noted above, staffing shortages and labor costs make this practice less than desirable. Second, patients often will not actively solicit information for preventive care; and rather will seek assistance when the care required is urgent.

There is a need for a method and apparatus adapted to provide health care information to patients that overcomes at least some of the shortcomings described above.

In accordance with an example embodiment, an apparatus includes a first station adapted to send, receive and process patient information. The apparatus also includes a second station comprising a video display and a user interface. The second station is adapted to send, receive and process and receive the patient information.

In accordance with another example embodiment, a patient information system includes a video display and a user interface adapted to interface the video display. The patient information system also includes a control module adapted to send, receive and process patient information and to display the patient information on the video display.

In accordance with yet another example embodiment, a method includes providing a video display and transmitting patient information between a clinician and a patient. Based on the patient information, the method includes providing the patient additional information through the video display.

The invention is best understood from the following detailed description when read with the accompanying drawing figures. It is emphasized that the various features are not necessarily drawn to scale. In fact, the dimensions may be arbitrarily increased or decreased for clarity of discussion.

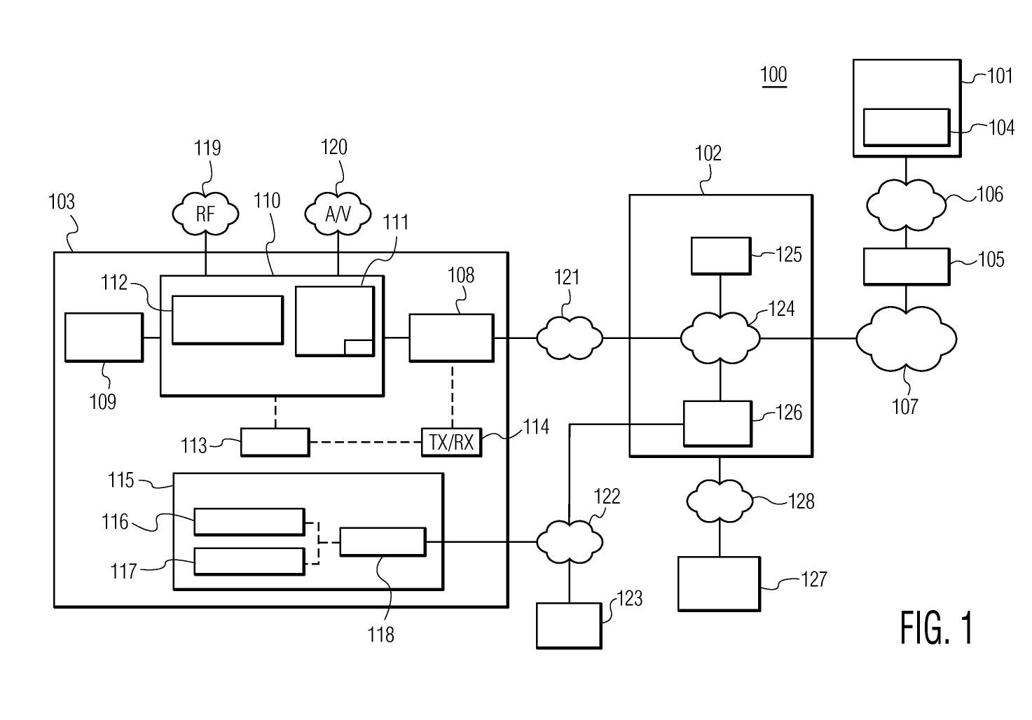

FIG. 1 is a simplified block diagram of a patient information system in accordance with an example embodiment.

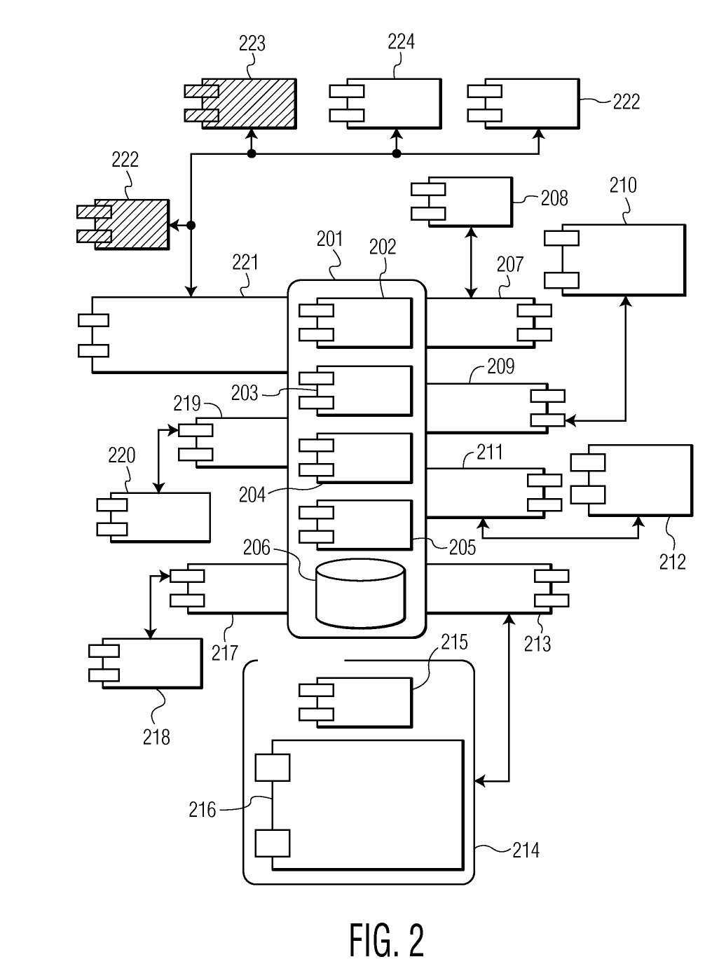

FIG. 2 is a simplified schematic diagram of a patient information system including an application core in accordance with an example embodiment.

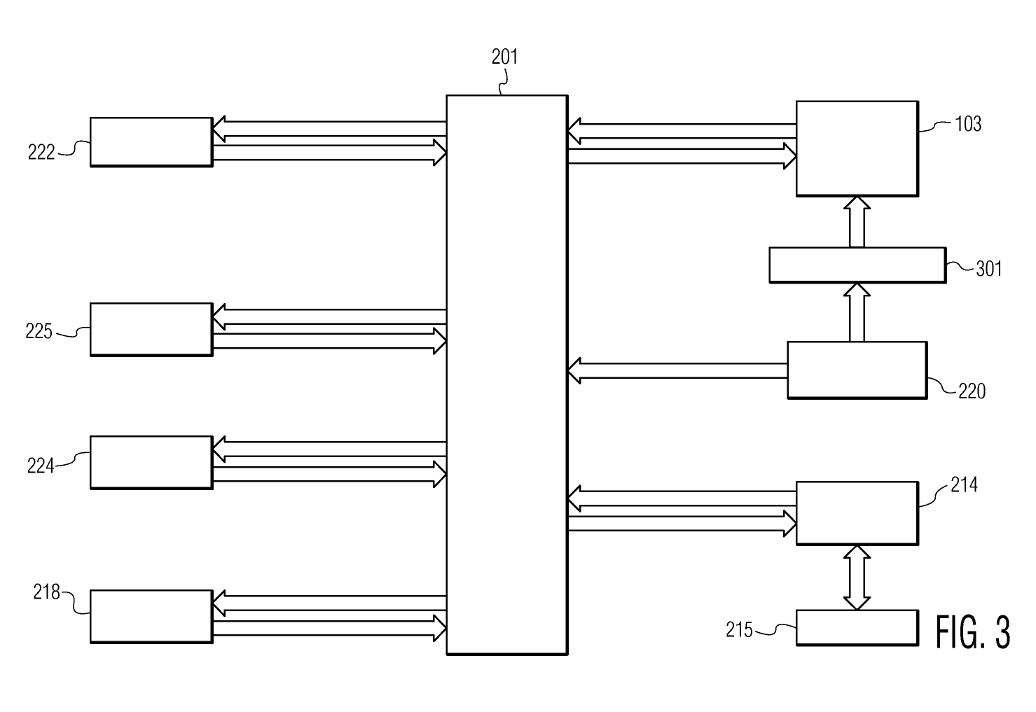

FIG. 3 is a flow-chart showing the transfer of information in a patient information system in accordance with an example embodiment.

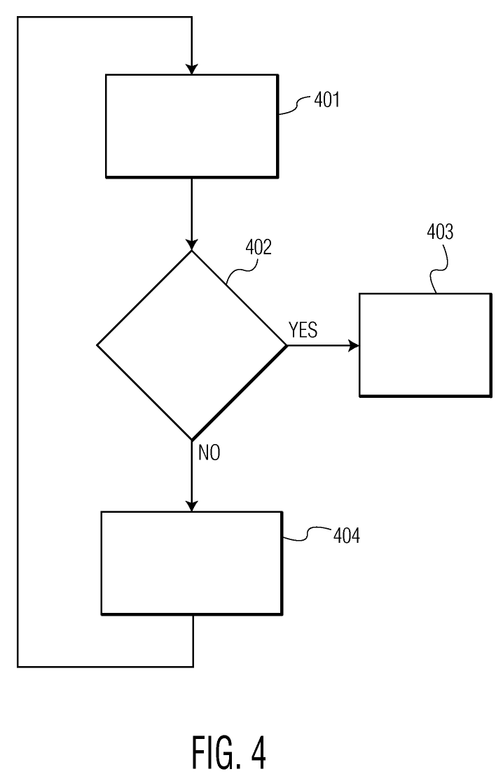

FIG. 4 is a flow-diagram of a method in accordance with an example embodiment.

In the following detailed description, for purposes of explanation and not limitation, example embodiments disclosing specific details are set forth in order to provide a thorough understanding of the present teachings. However, it will be apparent to one having ordinary skill in the art having had the benefit of the present disclosure that other embodiments that depart from the specific details disclosed herein. Moreover, descriptions of well-known devices, hardware, software, methods, systems and protocols may be omitted so as to not obscure the description of the example embodiments. Nonetheless, such hardware, software, devices, methods, systems and protocols that are within the purview of one of ordinary skill in the art may be used in accordance with the example embodiments. Finally, wherever practical, like reference numerals refer to like features.

As used herein, patient information includes, but is not limited to: patient medical history; patient biographical information; data from patient questionnaires and surveys; video programs (including audio); audio programs; audio messages; and video messages.

As described in conjunction with example embodiments herein, a patient information system provides a user-friendly interface between a patient and a clinician. A patient is provided with a control module that interfaces a video display such as a television in the patient's home. Patient information is provided from the patient to a clinician via a communication link. The information may be answers to questionnaires (surveys) provided to the patient and answered via the video display using a remote interface device, such as a remote control for the television. In addition, measurements such as weight may be provided through the communication link.

The information is provided to a host center that includes hardware and software that processes the information according to guidelines set for each patient. The information may also be provided to the clinician. In response to the information provided by the patient, the host center may determine an action to be taken and informs the patient, or to the clinician, or both, of the recommended action. For example, if a person has a diabetic condition and his/her blood sugar levels are elevated according to a recent measurement, the host center may issue an alert to the patient to take certain medication or action. Illustratively, this alert may be provided to the patient's television. Additionally, the clinician may be informed of the elevated measurement and may contact the patient through the patient information system to provide requisite care.

FIG. 1 is a simplified block diagram of a patient information system 100 in accordance with an example embodiment. The system 100 includes a first station 101, a hosting center 102 and a second station 103. The first station 101 may be located at a health care provider site such as a physician office or hospital and includes a terminal 104. The terminal 104 may be a personal computer having the requisite presentation layer software (user interface software) for interfacing with the host center 102 and the second station 103. The terminal 104 may be connected to a server 106 through a known intranet connection 105. The server 106 and the intranet connection 105 are well-known in to one skill in the art of information technology and as such are not described in detail to avoid obscuring the description of the embodiments.

In the example embodiment presently described, in the interest of simplicity of description, one first station 101, one host center 102 and one second station 103 are shown and described. However, it is contemplated that the patient information system 100 includes a plurality of the first stations 101, a plurality of hosting centers 102 and a plurality of second stations 103 as needed.

A secure link 107 provides the connection from the first station 101 to the host center 102. In a specific embodiment, the connection is includes encryption and other known security measures to provide a virtual private network (VPN) in accordance with the virtual private network consortium (VPNC). In this manner, the secure link 107 may be provided via public access links, such as telephone and coaxial cable lines. Alternatively, the first station 101 may be a wireless station of a wireless local area network wireless (LAN) or wireless wide are network (WAN), with the secure link 107 being a wireless link and including known encryption and security measures to ensure that information transmitted over the link is secure.

In a specific embodiment, the second station 103 is located in a patient's home or dwelling. The second station includes a control module 108 that interfaces with a video display 109. The connection to the video display 109 may be via an audio/video (av) switching device 110 that illustratively includes a switch 111 and a radio frequency (rf) modulator 112. Alternatively, another known type of input device adapted to provide an interface to the video display 108 may be used.

In a specific embodiment, the video display 109 may be a home entertainment display (e.g., a television) and the av switching device 110 is adapted to provide either television reception from the tuner of the display 109 or patient information reception/transmission from/to the host center 103. The av switching device 110 is known in the art and is optional as other hardware/software may be used to provide this function.

In other embodiments, the second station may be resident in a personal computer (PC), personal digital assistant (PDA), a mobile phone or a portable computer. As such, the display 109 may be a computer monitor or handheld communication device display, such as a portable phone, cellular phone or PDA. In the case of computers or mobile devices, the module 108 may be a component of the computer or device and the switching device is not included. It is emphasized that use of a mobile device or PC as the second station may be in addition to the second station's being in a patient's dwelling. Thereby, the patient may gain access to the system 100 via more than one link.

The control module 108 is often referred to as a set-top box. The control module 108 converts and displays data from analog cable, digital cable, or digital broadcast television to a standard channel frequency (channel number) for display on a standard analog television set. The control module 108 is also adapted to receive off-air digital television (DTV) signals for display on a DTV monitor. The control module 108 is adapted to receive signals (e.g., digital signals modulated by one of a variety of known methods) from the hosting center 103. The signals may include standard television signals and patient information signals from the host center 102.

As described in greater detail herein, patient information signals may include information, instructions and queries that are display on the video display 109 for information, or action, or both. The patient information signals may include video programs (including audio), audio programs, video messages and audio messages. Illustratively, the control module 108 includes a memory so that patient information signals can be stored for later use. When the switching device 110 is configured to transmit patient information signals, the control module 108 provides these signals to the display 109.

The second station 103 also includes a remote interface device 113 that provides signals to an infra-read transceiver 114. Signals to the transceiver 114 are provided to the module 108 and function to provide video input to the video display 109. In a specific embodiment, the device 113 is a remote control commonly used in entertainment displays. In other embodiments, the device may be an interface to a computer, such as a keyboard or ‘mouse.’

The second station 103 illustratively includes a patient telemonitoring set 115. The patient telemonitoring set 115 optionally includes at least one device adapted to take particular measurements of a patient on an intermittent or substantially continuous (e.g., monitoring) basis. For example, the patient telemonitoring set 115 may include a weight scale 116 or a sphygmomanometer 117 (blood pressure device) that are used intermittently. In addition, the telemonitoring set 115 may include a monitoring device such as an electrocardiogram (not shown) that a patient uses continuously for a defined period. The patient telemonitoring set 115 includes requisite connections/ports and adaptors for the devices implemented as well as additional ports/adaptors for devices to be added. Additionally, or alternatively, certain measurements may be manually entered by the patient. For example, the patient may provide a recent measurement (e.g., weight) at the video display 109 using the remote interface 112.

Data garnered from the devices of the patient telemonitoring set 115 or manually entered are provided to a measurement gateway 118, which transmits the data with patient identification to the host center 102 for processing and use in ways described in more detail. Alternatively or additionally, data garnered from the devices of the telemonitoring set 115 or manually entered may be provided to the control module 108, which transmits the data to the host center 102 for processing. The devices of the telemonitoring set 115 may be connected to the control module 108 via a wired or wireless link. For example, the devices and the control module 108 may be components of a LAN or wireless LAN.

The second station 103 may also include an rf source 119 and an av source 120 that are useful in providing links to the second station 103. Illustratively, the rf source 119 is a free-to-air antenna. The av source 120 may be a video input device such as a video cassette recorder (VCR), a digital video disc (DVD) player, or a satellite tuner, or similar device.

The second station 103 is connected to the host center 102 by a link 121, which is a wired or optical fiber link in the present example embodiment. The link 121 may be a coaxial cable-based broadband digital link, or a known relatively high data rate telephony-based link, such as a digital subscriber line (DSL) link or its progeny (XDSL). As will become clearer as the present description continues, it is useful for the link 121 to have sufficient capacity to ensure accurate and timely delivery of information between the second station 103 and the host center 102. It is emphasized that the use of a wired or fiber link is merely illustrative. To this end, it is contemplated that wireless links, including wireless network links and satellite links may be used to provide the link 121 to the host center 102.

In the present embodiment, the measurement gateway 118 may be connected directly to the host center 102 via a link 122. The link 122 may be a plain old telephone service (POTS) line, or may be a wired or wireless link such as noted above. Alternatively, the measurement gateway 118 may provide information via the link 121. This will require a connection to the link 121, which may be wired or wireless, as noted previously.

The patient information system 100 may include an order processing server (OPS) 123. As described more fully herein, the OPS 123 provides an interface for the system provider to update patient subscriber information. For example, the OPS 123 functions to provide installation orders to installers regarding a new patient. Upon installation, the new patient is provided the necessary hardware and software to access the system 100.

The hosting center 102 contains computer hardware, software and communications links to enable connectivity between the stations 101, 102. In a specific embodiment, the hosting center 102 includes an intranet server 124. The intranet server 124 may be provided by a broadband provider. Accordingly, information between the first station 101 to the third station 103 may be provided by the intranet server 124. In an example embodiment, the intranet server 124 may be a server of a local area network (LAN) or a wide area network (WAN). While the server 102 is connected between stations via a wired connection as described previously, it is contemplated that the connection may be wireless. In this case, the server 124 may be a wireless server of a wireless LAN or a wireless WAN.

In the example embodiments described herein, the hosting center 102 is centralized and includes various servers for specific functions. However, it is contemplated that the hosting center 102 may be distributed, with different components or sub-centers hosting different functions. In addition, there may be a plurality of hosting centers 102 that connect a plurality of second stations 103 with one or more first stations 101.

The hosting center 102 also includes a video server 125. As detailed herein, the video server 125 provides pertinent videos to the patient at the second station 103.

The hosting center 102 includes a measurement server 126 that receives data from the measurement gateway 118, or the control module 108, or both, and processes this information so a course of action, instructions or information may be provided to the patient. In addition, the measurement server 126 provides the data to a database (not shown in FIG. 1) for later use. Additional details of the components of the hosting center 102 and their function are provided herein.

Finally, the patient information system 100 optionally includes a third station 127. The third station 127 provides access to patient information by designated people. For example, designated family members and friends (F&F) may be provided access to the patient information system via the third station 127. This access is initiated by the OPS server 123 in much the same way that a new patient is provided access to the system 100.

In an example embodiment, the third station 127 includes an access terminal (not shown) that allows the user to receive and transmit information regarding the patient to the host center and thus to the first and second stations as needed. The access terminal may be a personal computer, a video display including a control module (e.g., control module 108), a PDA, a portable computer or a cellular telephone. The connection to the host center 102 may be wired or wireless such as the wired or wireless links described in connection with the connections of the first and second stations to the host center 102.

FIG. 2 is a simplified schematic diagram of a patient information system in accordance with an example embodiment. The schematic diagram of FIG. 2 includes many features common to those described in connection with the example embodiment of FIG. 1. Duplication of the description of the common features is normally avoided to avoid obscuring the present description.

The patient information system includes core 201 comprising hardware, software and firmware adapted to provide information, store information and determine courses of action to be provided to a patient based on information received from the patient. In an example embodiment, the core 201 is a set of services running on computer servers in hardware and software and located in the host center 102. Illustratively, the core 201 includes: a business logic (engine) 202; a rules engine 203; a reports engine 204; an applications (App) server 205; and a database server 206. The noted components of the core 201 are shown as distinct elements for ease of description. However, these components often have dependent functions.

The business logic 202 and rules engine 203 each include software and hardware adapted to receive information from a patient and, based on the information, provide a course of action. For example, if the information received is from a patient receiving treatment for heart failure indicates that the patient's blood pressure is above an acceptable threshold, the business logic 202 and rules engine 203 may provide an alarm to the patient's clinician and a message to the patient to take action such as taking medication, or contacting their clinician, or both. Thus, the business logic 202 and rules engine 203 receive information and algorithmically determine the course of action based on the information received.

Illustratively, the business logic 202 and rules engine 203 include database (computer) server hardware and software. The hardware is known to one of ordinary skill in the art. The software may include commercially available software including, but not limited to: Microsoft® SQL Server 2000 provided by MicroSoft (MS) Corporation, Seattle, Wash. USA; or Spring/iBatis provided the Apache Software Symposium; Java; or JESS, which is a Java rules engine provided by the Sandia National Laboratories. In accordance with example embodiment, the chosen software is modified to include code adapted to carry out the operations on the data and other inputs provided by the first station 101 and the second station 103. Illustratively, these operations may result in the instruction of an action to be taken and the conveyance of this instruction to the first station 101, or the second station 103, or both.

The reports engine 204 includes data garnered from each patient in the patient information system. Based on a command received, the reports engine 204 is adapted to provide specific information based on certain criteria. For example, the reports engine 204 may receive a command from the clinician for the blood pressure and weight of a particular patient over a specified time period. The reports engine 204 will engage the database server 206 for the relevant information and will generate a report for the clinician.

The reports engine 204 includes known database server hardware, which may be the hardware of the business logic 202 and the rules engine 203. The software is illustratively commercially available software modified to include code adapted to generate the desired reports. For example, Crystal Reports software offered by Business Objects, Inc. of San Jose, Calif. (USA) may be modified to include the requisite code to generate the reports.

The apps server 205 is a storage base of software required at the clinician site (first station 101), the host center 102 and the patient site (second station 103). The apps server 205 includes known database server hardware, which may be the hardware of the business logic 202 and the rules engine 203. The apps server 205 also includes commercially available software modified to include code adapted to provide software as needed to the clinician or the patient. For example, commercially available web-hosting application servers such as WebSphere offered by International Business Machines (IBM) of Armonk, N.Y. (USA) may be used.

The apps server 205 may be accessed via user interface (UI) level software of each site by known methods. For example, in an embodiment, the terminal 104 may require software to execute a desired function. The UI software (e.g., a browser) can access the apps server 205 for the needed program. The data base server 206 is a memory component of the core 201 adapted to maintain all data garnered from the system. In particular, the data base server 206 is the central repository for all the system data including, but not limited to types of care provided, user credentials, clinicians, patients, patient medical data, patient activity data and clinician activity. In an illustrative embodiment, the data base server 206 may be implemented in Microsoft® SQL Server 2000 provided by MicroSoft (MS) Corporation. The MS SQL server 2000 is an enterprise data management platform adapted to provide support for Extensible Markup Language (XML) and Internet queries. Of course, this is merely illustrative and other servers such as Oracle and MySQL servers may be used.

The core 201 includes a plurality of interfaces (I/Fs) adapted to provide access to the core for certain components of the system. Each of these I/Fs and linked components is briefly described. A more thorough understanding of the function of the I/Fs and components may be garnered from the description of FIG. 3.

A patient gateway I/F 207 is implemented in software and links a patient display (TV) UI layer 208 to the core 201. In an example embodiment, the patient gateway I/F 207 is implemented in XML over HyperText Transport Protocol (HTTP). Beneficially, the patient display (TV) UI layer 208 employs an user-friendly menu structure to navigate to different sections of the application. Because menu structures are readily understood by one skilled in the art, details are omitted to avoid obscuring the description of the example embodiments.

The patient TV UI layer 208 is implemented in software in the control module 108. Illustratively, the patient TV UI 208 is an open cable application platform specification (OCAP) (or, alternatively, a media home platform (MHP) operating system) that provides interactive services via satellite, terrestrial and cable networks. Alternatively, the TV UI can be implemented in a browser-based or a Java-based platform.

A measurement I/F 209 is implemented in software and links the measurement devices and medistation 210 to the core. Notably, the measurement devices and medistation 210 may be the patient telemonitoring set 115 of FIG. 1. The I/F 210 may be implemented in XML over HTTP or similar web service.

A computer telephony I/F 211 is implemented in software and provides a link to a computer telephony system 212. The system 312 may provide call center integration. Call-center integration can be used to directly route inbound calls to the appropriate clinical operator, or generate outbound calls (e.g., call campaign) for the purpose of clinical follow-up. In an embodiment, the hardware for the computer telephony I/F 211 is a computer server, which runs the application to integrate the clinician's computer (e.g., terminal 104) to the customer's telephone system equipment.

An OPS I/F 213 is implemented in software and provides a link to an OPS system 214, which is similar to the OPS 123 described in connection with FIG. 1. The OPS I/F 213 may be implemented in XML over HTTP, for example. The OPS system 214 includes an OPS portal 215 that is adapted to provide information from the order processing server 216. The server 216 performs tasks for establishing and updating patient services. For example, the installation of new service, shipping of equipment, inventory management, accounting and technical support may be provided by the OPS server 216.

A customer I/F 217 is implemented in software such as XML over HTTP. The customer I/F links a customer system 218 to the core 201. For example, the customer system 218 may be a hospital or care provider computer system (e.g., first station 101) that is used to provide patient information to the core 201 and to retrieve patient information from the core 201.

A partner I/F 219 is implemented in software such as XML over HTTP. The partner I/F 219 links a content partner UI 220 to the core 201. The content partner UI 220 provides information germane to patient care to the core 201 for dissemination to the patient as prescribed by the business logic 202 and rules engine 203. The content partner UI 220 may provide, for example video information on medical conditions. The content partner UI 220 provides access by a content partner to the core 201 so that updated and new information may be provided to the clinician and the patient. In a specific embodiment, the content partner UI may be implemented in the video server 125 of the host center 102.

A Web Applications Framework (WAF) I/F 221 is implemented in software such as XML over HTTP. Alternatively, the clinical UI may be a computer linked to a web server (often referred to as a Thick Client Application). Illustratively, the WAF I/F 221 includes a clinical I/F, a support I/F and Friends & Family (F&F) I/F and a web patient I/F.

The clinical I/F links a clinical UI 222 to the core 201. The clinical UI 222 may be implemented in Javascript language via hypertext markup language (HTML). In an embodiment, the clinical UI 222 is implemented in the first station 101 and provides the link of information from the clinician to the patient (e.g., second station 103) and allows the clinician to access information from the patient.

The support I/F 223 links a support UI 223 to the core 201. The support UI 223 may be implemented in Javascript via HTML and provides the patient access to a user support center (not shown) that provides technical support to the patient. For example, if the patient at the second station 103 is experiencing difficulty with one or more components of the station, the patient may engage a support menu on the video display 109 with the remote interface device 113. This support menu is provided through the support UI 223 and allows the patient to inform the support center of the difficulty encountered. The support center may then address the problem remotely through the support UI 223 or may provide remedial instructions to the patient via the video display 109 through the support UI 223.

The web patient I/F links a web patient UI 224 to the core 201. The web patient UI 224 may be implemented in Javascript via HTML and provides the patient access to the core 201 via an internet link. The web patient UI 224 is implemented at the terminal or computer of a patient. In an example embodiment, the web patient UI 224 provides a patient that prefers to have access to the patient information system via the internet. For example, instead of or in addition to having an interactive video display in the second station 103, a personal computer (not shown) may provide the same functionality for the patient as the interactive video display 109. Notably, the internet access may be via a wired link, or a wireless link, or both.

The link via the patient's personal computer provides the interface with the display of the computer via a keyboard or a mouse. These types of interactive interfaces and their supporting hardware and software are known. Usefully, the patient may be provided with alternate access to the patient information system. Furthermore, with the ubiquitous availability of internet access, the patient may access the system via a portable computer, a cellular phone or a personal digital assistant (PDA). Of course, the requisite web patient UI software would be provided on such devices.

The F&F I/F links a F&F UI 225 to the core 201. The F&F UI 224 may be implemented in Javascript via HTML and provides the family of the patient and other permitted people access to the core 201. This UI is similar to the web patient UI and may be realized through a personal computer, cell phone or PDA. Notably, the F&F UI 225 allows the friends and family of the patient to garner information useful in patient care, for example.

In an example embodiment, the friend or family member is granted access to the patient information system and gains access through a third station 127, which is illustratively a personal computer, a portable computer, a PDA, a cell phone, or a video display. The connection to the core 201 is via the F&F UI 225. The hardware and software required of the third station is similar to that required of the second station. Moreover, the link to the core 201 is secure, illustratively a VPN link.

The clinician may provide instructions to or garner information from the friends and family of the patient as needed. For example, the patient may be unresponsive to a query from the clinician. The clinician may then access a family member through the F&F UI 225 alerting them to any issues or concerns.

FIG. 3 is a flow diagram showing the flow of data through the various components of a patient information system in accordance with an example embodiment. The present description is best understood when reviewed with of FIGS. 1 and 2 concurrently.

The clinical UI 222 located at the first station 101 provides information from the clinician to the core 201. For example, the clinician may provide greetings, messages, goals and measurement trends that are specific to the patient. The clinical UI 222 may also provide survey assignments to the patient and video assignments to the patient.

The second station 103 includes the patient TV UI 208, the control module 108 and the measurement devices of the patient telemonitoring set 115. The second station 103 provides measurements data to the core 201 via the measurements I/F 209. These data are provided to the measurements server 126, which provides the data to the rules engine for analysis. Moreover, and as discussed more fully herein, the second station transmits survey results to the core 201, which may provide these to the business logic 202 and rules engine 203 and the database server 206.

Survey assignments are interactive surveys/questionairres provided to the patient at the second station 103. These surveys have targeted questions that are loaded on the control module 108 and viewed on the video display 109. The patient uses the remote interface device 113 to select choices for each question presented. In an example embodiment, the survey assignments are provided from the clinical UI 222 via the clinical I/F to the business logic 202 and rules engine 203 for assignment to the recipient patient. The business logic 202 and rules engine 203 then provides the survey to the patient gateway I/F 207 and then second station 103 via the patient TV UI 208 and the control module 108.

Upon completion of the survey, the second station 103 returns the resultant data to the clinician UI 222 via patient gateway I/F 207, the business logic 202 and rules engine 203 and the clinical I/F. These data are then compiled by the clinical UI 222 for further use. In addition, the data from a survey may be used by the reports engine 204, which garners needed information from the database server to complete a report. Furthermore, the business logic 202 and rules engine 203 may algorithmically analyze the data from the survey and provide a course of action to the patient.

As noted, the clinician at the first station 101 may provide video information to the patient at the second station 103 via the video display 109. This video may be generic to all patients having a particular medical condition, or may be tailored to the recipient based on his/her particular situation. For example, based on measurement trends and survey results, the video may provide the patient with tailored instructions for activity, nutrition and medication. Of course, this is merely illustrative of the types of videos that may be provided.

The measurements from the patient telemonitoring set 115 are provided via the clinical UI 222 to the clinician. The business logic 202 and rules engine 203 receive the results from the measurement server 126 and analyzes the data for the particular patient. Thus, patient information is provided via a header in the data identifying the patient and the second station sending the data. As described previously, the business logic 202 and rules engine 203 include software adapted to analyze the measured data and provide a course of action responsive to the analysis. For example, if the data show that a patient's measurements require immediate attention, the rules engine may convey this to the clinician at the first station 101 via the clinical UI 222, or to the patient at the second station 103, or both. The business logic 202 and rules engine 203 are also adapted to provide a proposed course of action. This information may also be conveyed to the clinician at the first station 101 or the patient at the second station 103, or both. The clinician may then act to inform the patient of the need for immediate attention and the course of action to be followed. Again, this information passes through the core 201 to the patient at the second station 103, where it is conveyed to the video display 109 by the control module 108.

Notably, the business logic 202 and rules engine 203 may provide a different response to received measurement data. For example, if a patient's measurement indicates progress in an area of concern for his/her condition, the business logic 202 and rules engine 203 may provide a message of encouragement along with the measurement analysis on the display 109. In a specific embodiment, the clinician at the first station 101 provides the message and analyses as described. Alternatively, the message and information may be returned directly by the business logic 202 and rules engine 203 without input from the clinician

The F&F IU 225 and web patient UI 224 are shown together in FIG. 3. The F&F UI 225 is adapted to garner patient information by soliciting this information from the first station 101 via the clinical UI 222, or may be provided the information according to established criteria. For example, if a patient's family wishes to know the patient's progress in a particular area of concern, the family may provide a query to the clinician via the F&F UI 225. The query is routed through the business logic 202 and rules engine 203 and to the clinician at the first station via the clinical UI 222. The business logic 202 and rules engine 203 applies certain algorithms to the query before providing the query to the clinician and back to the family. For example, as a result of completing a survey, a patient may deny family members access to certain information. In this case, the clinician would be notified and a suitable response would be provided. Notably, the transfer of information may be from the family via the F&F UI 225 to the business logic 202 and rules engine 203 and the response provide by the business logic 202 and rules engine 203 to the family without notice to the clinician at the first station 101.

The web Patient UI 224 provides and receives similar information and in much the same manner as the patient at the first station 103 as described previously.

A support site (not shown) interfaces the core 201 via the support UI 224 and provides patient enrollment and termination of service information to the database server 206 via the business logic 202 and rules engine 203. This information may be garnered from the patient via the patient UI. In addition, as noted previously, the support UI 224 provides access to technical support as needed by the patient or clinician, or both. The support UI 224 provides the requests to the business logic 202 and rules engine 203, which determine an action to be taken. For example, this action may be to provide required software from the apps server 205 or to provide information to the patient to fix the problem. In addition, the business logic 202 and rules engine 203 may alert a technician at the support site of the need to perform an equipment repair. Notably, the repair may result from a fault message from the second station 103 received by the business logic 202 and rules engine 203.

The customer system 218 interfaces the core 201 via the customer I/F 217 as described above. The customer system 218 provides patient information and demographics to the database server 206 and the business logic 202 and rules engine 203. The business logic 202 and rules engine 203 in turn may provide measurement analyses and health status information for each patient to the customer system 218.

The OPS system 215 interfaces the core 201 via the OPS I/F 213. The OPS system provides installation and device information to the business logic 202 and rules engine 203. The business logic 202 and rules engine 203 updates the database server 206, provides needed access to the apps server 205 and assigns tasks to technicians at the support site. In this manner, new patients may receive their equipment and technical support to commence use of the patient information system of the example embodiments. The OPS system may receive enrollment information, patient demographics and technical support requests. This information may be provided by the database server 206, the reports engine 204, the business logic 202, or rules engine 203, or a combination thereof.

The content partner 220 interfaces with the core 201 via the content partner I/F 221. The content partner 220 may provide informative or interactive video to the patient at the second station 103 directly through the core, or via a direct link to the patient via a video content server 301 as shown. The link from the video content server 301 to the patient may be via a/v source 120 or the rf source 119.

As noted previously, the content partner 220 provides video to the patient that is generic or patient specific. The patient specific video is developed by the content partner based on information received from the database server 206 and may be tailored based on instructions from the business logic 202 and rules engine 203.

FIG. 4 is a flow-diagram of a method in accordance with an example embodiment. Many features of the method of the present embodiment are common to those described previously. In general, the description of these common features is not repeated.

At step 401, patient information is provided to the host center 102. This information is provided from the second station 103 to the host center 102 and may include a response to a survey or other query addressed via the interactive video display 109, or measurement data from devices of the patient telemonitoring set 115.

At step 402, based on the patient information received, the method includes an inquiry whether the patient is in need of urgent care. For example, the patient information (data) may be processed at the business logic 202 and rules engine 203 via a resident algorithm. If after the data are processed it is determined that the patient requires immediate attention, at step 403, action is taken to provide urgent care. For example, if the algorithm mandates immediate care, the core 201 may transmit a message to the clinician at the first station 101 and to the patient at the second station 103 recommending the urgent care required. This may then result in action by the patient, or the clinician, or both. For purposes of illustration, if the results of an electrocardiogram (EKG) from the patient's measurement gateway 118 were indicative of imminent heart failure, the algorithm at the business logic 202 and rules engine 203 may trigger the contacting of the patient via the video display 109 or via an automated phone call. Simultaneously, the business logic 202 and rules engine 203 may contact the clinician via the terminal 104 or telephonically. The business logic 202 and rules engine 203 may also be adapted to contact ambulatory services as well. Because the patient's vital information is included with the patient information, the location of the patient is immediately known.

Alternatively, the patient information garnered in step 402 may indicate that no urgent care is needed. Again, the business logic 202 and rules engine 203 process the data (patient information) and algorithmically determines an action to be taken. At step 404 the patient is provided with information based on the algorithm. For example, the patient may be provided a message, or a relevant video, or another survey, or a combination thereof. Illustratively, the business logic 202 and rules engine 203 algorithmically determines the appropriate message, video or survey. These are then provided to the patient TV UI via the patient gateway I/F.

Upon completion of step 404, the process may continue at step 401. In particular, depending on the patient's needs, patient information is transmitted to the host center 102 and the clinician as described. This process may be continual or continuous depending on the patient's needs and course of treatment.

Notably, the absence of receipt of information from the patient at step 401 may result in the transmission of information to the patient at step 404. For example, suppose a patient is to provide a survey by a certain date or is scheduled to make a measurement at a particular interval of time. If, by the appointed time, step 401 is not completed, the business logic 202 and rules engine 203 trigger an action to query the patient for the information in the manner of step 404. For example, a video message may be sent reminding the patient of the overdue patient information. Of course, this process may be regularly repeated until step 401 is completed so that the remaining steps of the method can be completed.

### EXAMPLE

The following is an example provided to illustrate certain aspects of the patient information system according to illustrative embodiments. The example is in no way limiting and it is emphasized that other applications are contemplated.

A patient has heart failure. The clinician determines the patient needs to follow a preventive health plan including healthier eating, loosing weight, exercising more, medication compliance, etc.

After being established in the patient information system via the support site as described above, the clinician provides a survey to the control module 108 that the patient can complete via the interactive video display 109. The survey collects information about:
Lifestyle, such as
Capability to exercise
Mobility
Independence
Mental Health
Financial status
Smoking
Alcohol consumption
Medical History, such as
Disease stage
Family history
Hospitalizations (dates, cause for admission, length of stay)
Allergies to food
Allergies to medication
Ethnicity
Current Health Status, such as
Baseline health parameter values (weight, bp, etc.)
Baseline lab values (cholesterol, wbc, etc.)
Current medications

The data from the completed survey is provided from the control module 108 to the hosting center 102, and particularly to the core 201 located at the hosting center via the patient gateway I/F 207. The data is provided to the business logic 202 and rules engine 203 that algorithmically determine that the appropriate course of action is a care plan for a patient with advanced heart failure and diabetes. The course of action is provided to the clinician at the first station 101 via the clinical I/F and clinical UI 222. The clinician reviews this plan and approves the transmission of the plan to the patient. The business logic 202 and rules engine 203 algorithmically determine the appropriate plan for the patient based on information from the survey including lifestyle, medical history, and current health status.

For example, suppose the patient lives alone, is relatively sedentary, a non-smoker but drinks moderately. The patient is also currently taking four different medications. The business logic 202 and rules engine 203 present a care plan tailored to the patient's circumstances, which would include in the first module:
Heart Failure with Diabetes
A beginner's guide to exercising with heart failure
eating healthy for one
how to take your weight daily
weekly pill reminders
assessments via survey to track care plan progress

The core 201 delivers the care plan to the control module 108 via the hosting center 102, and the patient starts to follow the personalized care plan. From the data gathered from measurements, surveys, and usage patterns, the business logic 202 rules engine 203 detect that the patient is gaining weight (rather than loosing weight). The business logic 202 and rules engine 203 automatically transmit a survey to find out if the patient has been exercising, the patient's diet and similar questions designed to address the weight gain. Suppose that based on the responses to this survey, the business logic 202 and rules engine 203 determine that the patient is not fully informed of the diagnosis, does not follow the diet recommendations, and does not take the prescribed medication regularly.

In this event, the business logic 202 and rules engine 203 adjust the care plan to match the patient's capabilities. For example, the business logic 202 and rules engine 203 may instruct the video server 125 to provide a basic video on the patient's condition; and may increase the frequency of messages to the second station 103 reminding the patient to take medication.

In view of this disclosure it is noted that the various methods and devices described herein can be implemented in hardware and software. Further, the various methods and parameters are included by way of example only and not in any limiting sense. In view of this disclosure, those skilled in the art can implement the present teachings in determining their own techniques and needed equipment to effect these techniques, while remaining within the scope of the appended claims.

1. An apparatus, comprising:
a first station adapted to send, receive and process patient information; and
a second station comprising a video display and a user interface, wherein the second station is adapted to send, receive and process the patient information.

2. An apparatus as recited in claim 1, wherein the video display is a display of a home entertainment device.

3. An apparatus as recited in claim 1, wherein the video display is one or more of: a computer display; a mobile telephone display; a personal digital assistant display.

4. An apparatus as recited in claim 1, wherein the user interface further comprises a remote interface device adapted to transmits signals to a control module that interfaces with the video display.

5. An apparatus as recited in claim 1, further comprising a host center that connects the first station to the second station.

6. An apparatus as recited in claim 4, wherein the control module is adapted to process the patient information and display the patient information on the video display.

7. An apparatus as recited in claim 1, further comprising at least one measurement device adapted to take measurements from a patient and to provide data from the measurements to the first station.

8. An apparatus as recited in claim 7, further comprising a measurement server adapted to gather data from the measurements and to provide the data to the first station.

9. An apparatus as recited in claim 1, wherein the first station is located in a health care facility and the second station is located in a patient's dwelling.

10. An apparatus as recited in claim 1, further comprising an application core having a rules engine adapted to receive the patient information and to provide recommended actions based on the received patient information.

11. An apparatus as recited in claim 1, further comprising: a video server adapted to provide video programs to the second station based on the patient information received from the second station.

12. An apparatus as recited in claim 5, wherein a connection between the first station and the host center is a virtual personal network (VPN) connection.

13. An apparatus as recited in claim 5, wherein a connection between the first station and the host center and a connection between the second station and the host center are wired connections.

14. An apparatus as recited in claim 13, wherein the wired connections are one or more of: a digital subscriber line (DSL); a coaxial cable connection; a fiber optic connection.

15. An apparatus as recited in claim 5, wherein a connection between the first station and the host center and a connection between the second station and the host center include wireless connections.

16. An apparatus as recited in claim 1, further comprising a third station adapted to receive the patient information from the first station, or the second station, or both.

17. A patient information system, comprising:
a video display;
a user interface adapted to interface the video display; and
a control module adapted to send, receive and process patient information and to display the patient information on the video display.

18. A patient information system as recited in claim 17, wherein the video display is one or more of: a computer display; a mobile telephone display; a personal digital assistant display.

19. A patient information system as recited in claim 18, wherein the user interface further comprises a remote interface device adapted to transmits signals to a control module that interfaces with the video display.

20. A method, comprising:
providing a video display;
transmitting patient information between a clinician and a patient; and
based on the patient information, providing the patient additional information through the video display.

21. A method as recited in claim 20, further comprising providing: a control module that is adapted to interface with the video display; and a remote interactive device adapted transmits signals to the control module.

22. A method as recited in claim 20, wherein the transmitting patient information further comprises taking measurements from the patient and transmitting data from the measurements to the clinician.

23. A method as recited in claim 21, transmitting patient information further comprises:
providing at least one query to the control module;
displaying the at least one query on the video display; and
providing at least one response to the at least one query via the control module to the clinician.

24. A method as recited in claim 22, wherein the additional information includes instructions for behavior modification to the patient.

25. A method as recited in claim 20, wherein the additional information is a video program.

26. A method as recited in claim 25, further comprising tailoring the video program for the patient based on the patient information.

27. A method as recited in claim 25, further comprising storing the video program on a control module.
